(19) United States
(12) Patent Application Publication
(10) Pub. No.: US 2017/0232331 A1
(43) Pub. Date: Aug. 17, 2017

(54) RANDOM PATTERN CONNECTION GAME AND METHOD OF PLAYING SAME

(71) Applicants: Charles D. Dulin, Phoenix, AZ (US); David M. Dulin, JR., Phoenix, AZ (US); Kendra L. Inman, Phoenix, AZ (US)

(72) Inventors: Charles D. Dulin, Phoenix, AZ (US); David M. Dulin, JR., Phoenix, AZ (US); Kendra L. Inman, Phoenix, AZ (US)

(21) Appl. No.: 15/425,221

(22) Filed: Feb. 6, 2017

Related U.S. Application Data
(60) Provisional application No. 62/292,133, filed on Feb. 5, 2016.

(51) Int. Cl. A63F 3/00; A63F 13/25

(52) U.S. Cl. CPC A63F 3/00634; A63F 13/25; A63F 3/00173; A63F 2003/00637; A63F 2003/00406

(57) ABSTRACT

A random pattern connection game with a physical version or computerized representation of a substantially cylindrical polygonal shaped grid with vertical columns and horizontal columns to create a plurality of slots at the top end of the vertical columns to receive game pieces; and a visual indicia displaying at least one random game piece grid pattern comprising. The game is playing by providing a plurality of game pieces to a group of players; providing a cylindrical or polygonal shaped grid with vertical and horizontal columns to receive game pieces; dividing the game pieces between the players; and generating a random game piece grid pattern wherein each player attempts to recreate the grid pattern by alternating turns for inserting game pieces into the top of a vertical column such that the game piece falls straight down and occupies the next available space in the vertical column.

### RELATED APPLICATIONS

This application claims priority to U.S. Provisional Application No. 62/292,133 filed Feb. 5, 2016. The entire contents of the above application are hereby incorporated by reference as though fully set forth herein.

### FIELD

The present invention relates to games, and more in particular to a game in which players duplicate a particular arrangement of playing pieces in a plane or space.

### BACKGROUND

Games that require players to strategically drop colored game pieces down multiple contiguous vertically aligned columns, stacking pieces on top of one another, until one player achieves a specific pattern with their game pieces and wins, are known in the prior art. However, the present invention uses an improved upon game grid and used playing cards, dice or electronic means to randomly generate one out of a plurality of possible patterns a player must create on the game grid to end the game.

For example, “Connect 4”® by Hasbro is a two-player connection game. Players choose a color and take turns strategically dropping their game pieces into the top of a seven-column, six-row vertically suspended rectangular grid. The rectangular grid has a top, bottom and two sides. Players insert game pieces into the top of a vertical column of their choice. The piece falls straight down and occupies the next available space within the column. The objective of the game is to be the first player to connect four of one's own pieces next to each other in one of three possible patterns (vertically, horizontally, or diagonally) on the grid. “Connect 4”® and similar games are “solved games”, which means the first player always wins with perfect game play.

The present invention seeks to provide a game that can be played by two or more players that is an unsolved game, meaning that any player can win, regardless of which player goes first. The objective of the game is to be the first player to recreate a random pattern with one's own pieces on the grid.

### BRIEF SUMMARY OF THE INVENTION

The present invention is a random pattern connection game with a plurality of sets of game pieces; a physical version or computerized representation of a substantially cylindrical polygonal shaped grid with vertical columns and horizontal columns to create a plurality of slots at the top end of the vertical columns to receive game pieces; and a visual indicia displaying at least one random game piece grid pattern comprising. The method for playing the game comprises providing a plurality of game pieces to a group of players; providing a cylindrical or polygonal shaped grid with vertical and horizontal columns to receive game pieces; dividing said plurality of game pieces between said players so that each player has a predetermined number of tiles and each player's game piece is uniquely identifiable to that player; and generating a random game piece grid pattern wherein each player attempts to recreate the grid pattern by alternating turns for inserting their uniquely identified game pieces into the top of a vertical column such that the game piece falls straight down and occupies the next available space in the vertical column.

The game pieces may be markers, tokens, tiles or electronic representations. Colors, shapes or other physical or electronic markings may uniquely identify them. The random grid pattern may be generated on a playing card, dice, or an electronic method. In the preferred embodiment, the grid is an eight column, eight row vertically suspended polygonal structure with a top and bottom and wherein the columns themselves comprise the side walls.

### BRIEF DESCRIPTION OF THE DRAWINGS

FIG. 1 is front perspective view of the device of the present invention without the base.

FIG. 2 is a top view of the device of the present invention.

FIG. 3 is a front view of the device of the present invention with the base.

FIG. 4A is top view of the game piece of the present invention.

FIG. 4B is a side view of the game piece of the present invention.

FIG. 5 is a bottom view of the polygonal tower of the present invention.

FIG. 6 is a top view of the base of the present invention.

FIG. 7 is an overview schematic of a three person game played on the game grid.

FIGS. 8A-8E are illustrative examples of the grid random game patterns.

### DETAILED DESCRIPTION

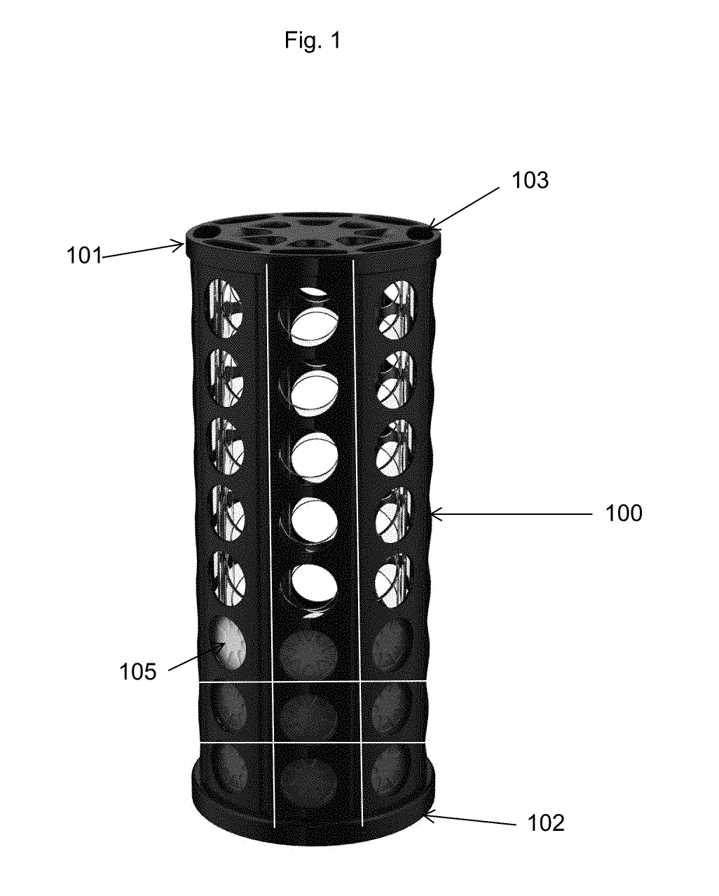

Turning to FIG. 1 a substantially cylindrical polygonal shaped grid 101 with vertical columns and horizontal columns to create a plurality of slots 103 at the top end of the vertical columns to receive game pieces 105. The grid is between a top end piece 101 and bottom end piece 102. In the preferred embodiment there are at least eight columns and at least eight rows.

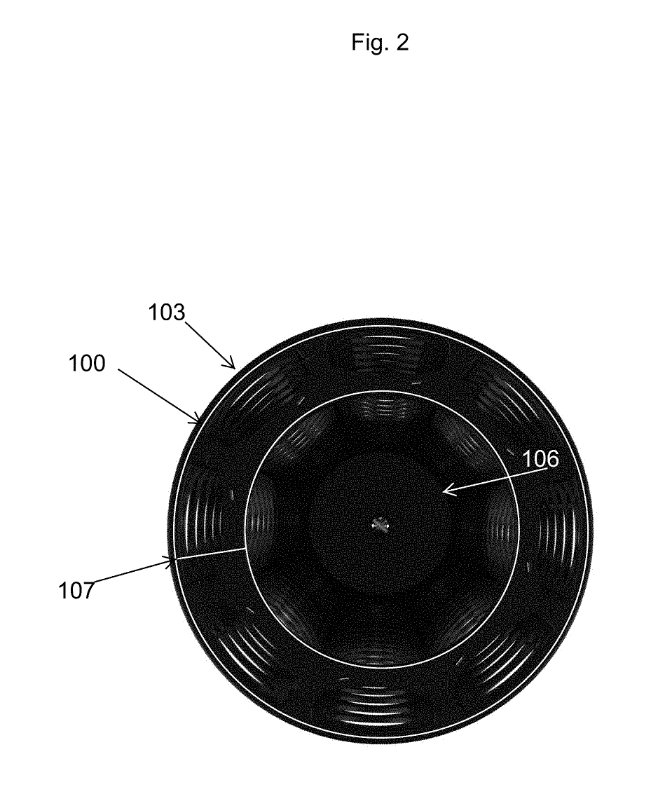

Turning to FIG. 2, the top view shows polygonal grid 100 formed by eight columns making a cylindrical shape wherein each side 107 is about 3.6 cm wide and the center cross-section 106 can be hollow, solid or gradations between hollow and solid. Game pieces are inserted into slots 103

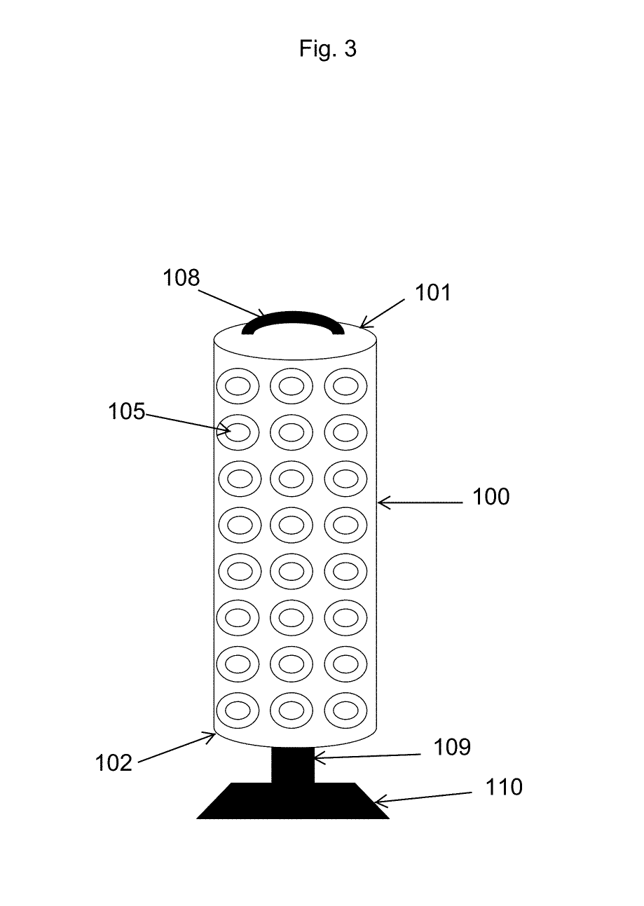

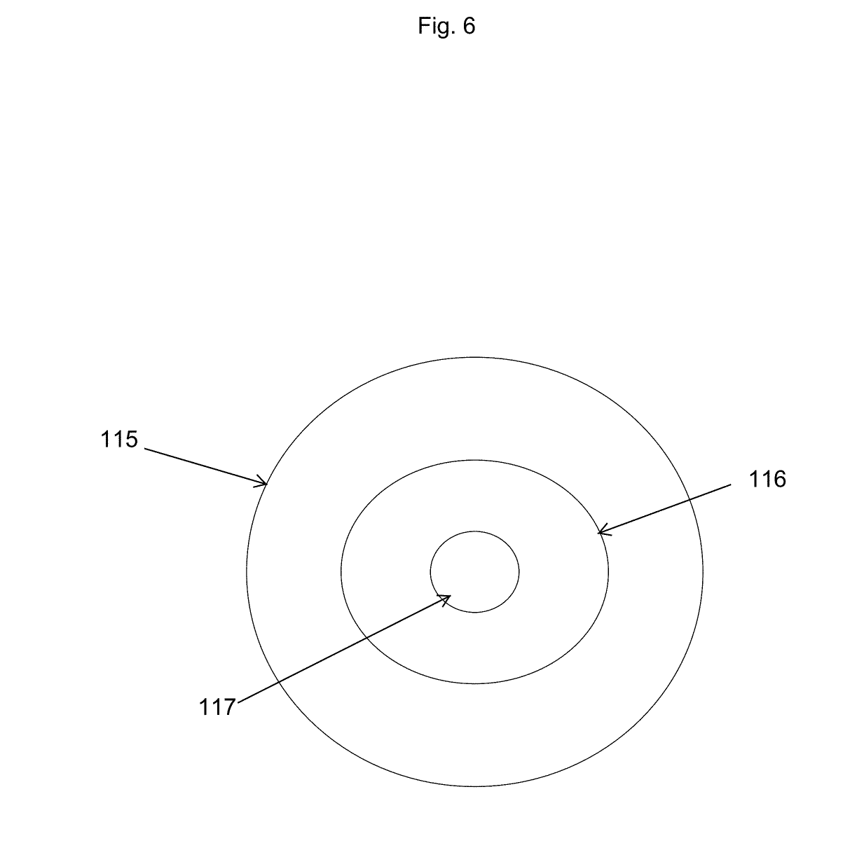

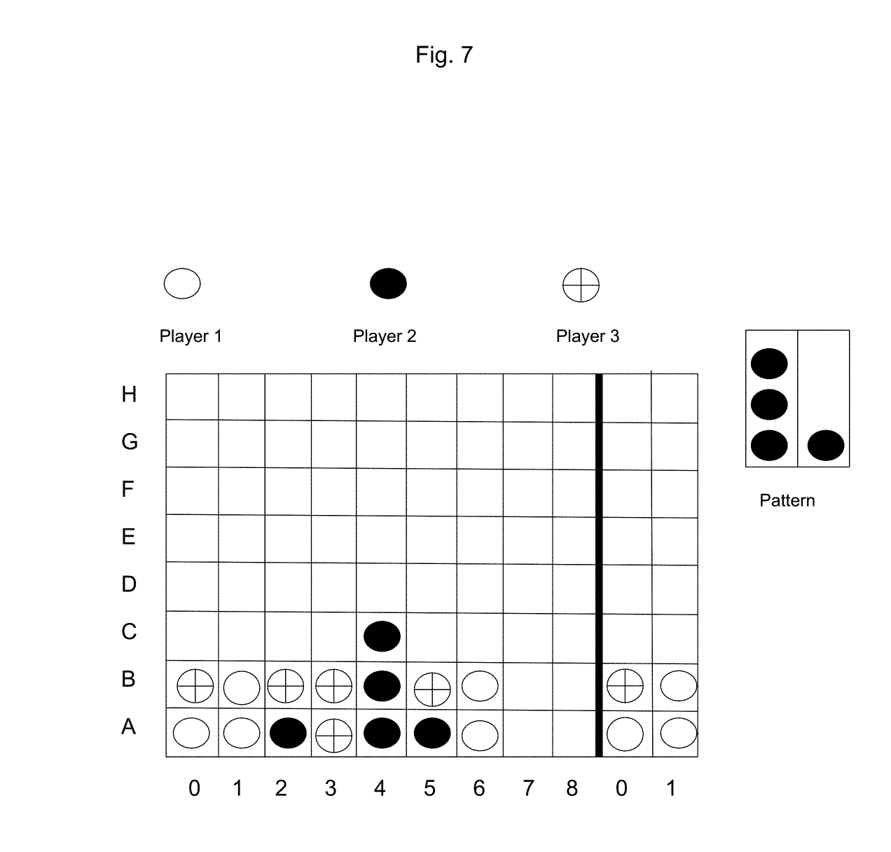

Turing to FIG. 3, the polygonal shaped grid 100 fits into or onto the pedestal 109 that extends upward from the substantially planar base 110. The base 102 remains stationary while pedestal 109 rotates within the base 110 thereby causing the polygonal grid 100 to rotate 360 degrees. Alternatively, the base 102 and pedestal 109 may remain stationary while the polygonal grid 100 rotates 360 degrees. The top portion 101 may be a handle piece 108 for easy of transporting the device. As shown in further detail in FIG. 5-6, the bottom portion 113 of the polygonal grid has a female connector 114 and the base 115 has a pedestal portion 116 extended from the base with male connector 117. The male connector 117 of the base 115 fits into the female connector 114 of the bottom portion 113.

Turning back to FIGS. 1-2, the game pieces 105 are inserted into slots 103 in any of the vertical columns such that the game piece falls straight down and occupies the next available space in the vertical column. In electronic format, the player would indicate that game piece 105 is inserted into slot 103 in any of the vertical columns and the game piece would automatically occupy the next available space in the vertical column.

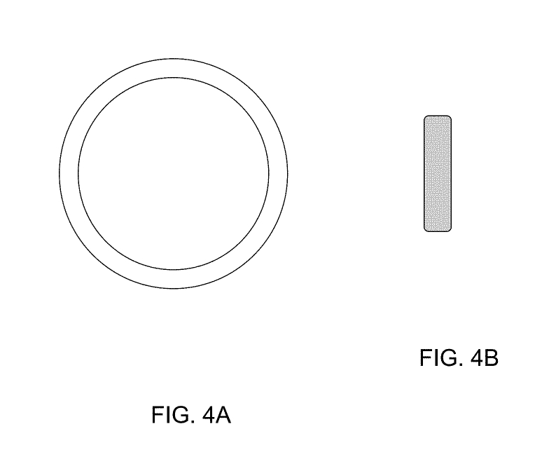

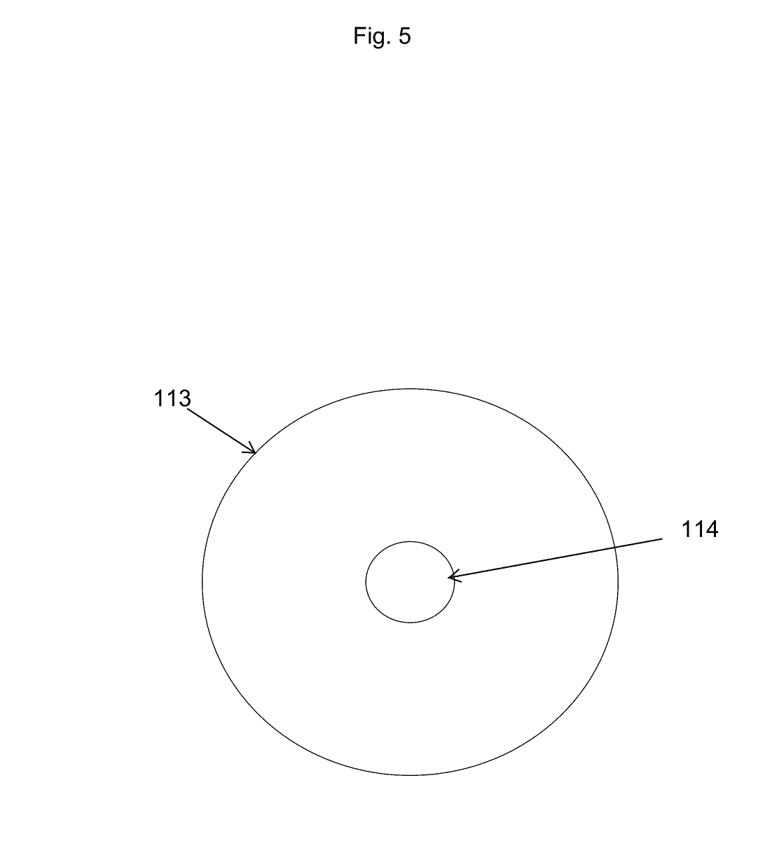

The game pieces 105 can be markers, tokens, tiles or electronic representations of same. For example, as shown in FIGS. 4A-B, a substantially round token is used. In the preferred embodiment, the slots 103 are about 1.0 cm wide and the game pieces are about 0.6 cm wide; however, any size wherein the game pieces are slightly less wide than the slots 103 could be used. Alternatively, the slots could be “virtual” wherein the size is not important so long as the electronic game piece sits in the desired spot on the grid 100 after placement.

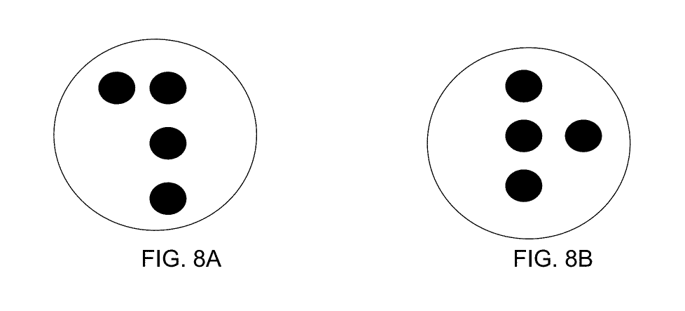

Turning to FIG. 7, a three-person game schematic is shown wherein a randomly selected pattern is used by the three players. However, it should be noted that any combination of two or more players could play the game. The players take turns inserting their game pieces into the polygonal grid in an attempt to recreate the winning game pattern. The grid shown in FIG. 7 is a flat version representation of the cylinder tower shown in FIGS. 1 and 3 such that the column labeled “0” is connected to the column labeled “8” in a cylindrical fashion. In this case, the game pieces are uniquely identified as an empty circle for player 1, solid circle for player 2 and plus sign for player 3. The players alternate turns inserting their game pieces into the cylindrical grid shown in FIG. 1 until a player successfully creates the randomly selected pattern from FIG. 7.

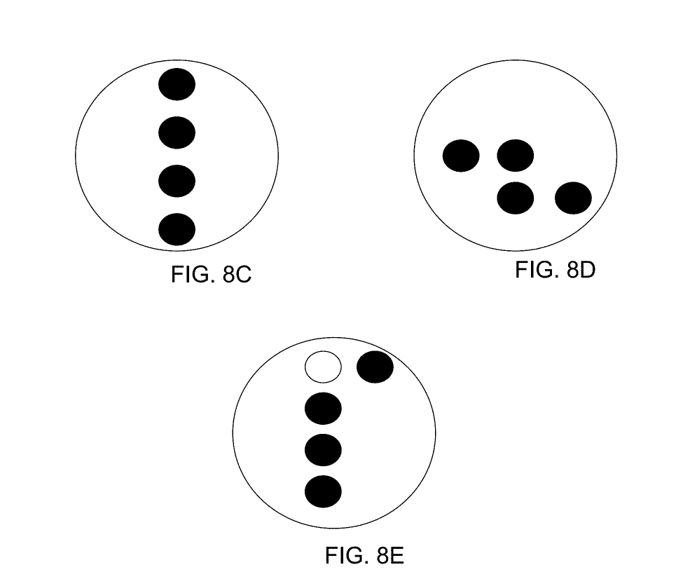

Turning to FIGS. 8A-3E, several examples of randomly selected visual indicia patterns are shown. These patterns may be displayed on playing cards, dice or even an electronic representation.

The random pattern connection game is played by (1) providing sets of game pieces to a group of players wherein each set of game pieces are uniquely identifiable and associated with different game players; (2) providing the substantially cylindrical polygonal shaped grid described above, with vertical columns and horizontal columns to create a plurality of slots at the top end of the vertical columns to receive game piece; and (3) generating a visual indicia of a random game piece grid pattern on playing cards, dice or by electronic means. The players attempt to recreate the grid pattern by alternating turns for inserting their uniquely identified game pieces into the top of a vertical column such that the game piece falls straight down and occupies the next available space in the vertical column.

An additional embodiment of the present invention is a computerized random pattern connection game for a gaming machine that uses a central processing unit, a visual display of a random pattern connection game device described above, a visual indicia displaying at least one random game piece grid pattern, and at least two sets of computer-generated player game pieces. A player input mechanism interfaces with the central processing unit and is responsive to player commands to place game pieces in the device. A computer program generates a visual indicia displaying at least one random pattern and places player game pieces on the visual display of the game device in response to player commands to effect movement of the player game pieces on the visual display of device.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A random pattern connection game comprising:
a. a plurality of sets of game pieces;
b. a substantially cylindrical polygonal shaped grid with vertical columns and horizontal columns to create a plurality of slots at the top end of the vertical columns to receive game pieces; and
c. a visual indicia displaying at least one random game piece grid pattern
wherein each set of game tokens are uniquely identifiable and associated with different game players; and
wherein the game pieces are inserted in alternating turns by the players into the top of a vertical column such that the game piece falls straight down and occupies the next available slot in the vertical column.

2. The random pattern connection game of claim 1 wherein the game pieces are selected from the group comprising markers, tokens, tiles or electronic representations of same.

3. The random pattern connection game of claim 1 further comprising playing cards, wherein the visual indicia of the random game piece grid pattern is displayed on the playing cards.

4. The random pattern connection game of claim 1 further comprising dice, wherein the visual indicia of the random game piece grid pattern is displayed on the dice.

5. The random pattern connection game of claim 1 wherein the polygonal grid has at least eight columns and at least eight rows.

6. The random pattern connection game of claim 1 wherein the game pieces are slightly smaller than the slots at the top end of the vertical columns.

7. The random pattern connection game of claim 1 further comprising a base wherein the polygonal shaped grid fits into or onto the base and the base remains stationary while the polygonal grid rotates 360 degrees.

8. A method of playing a random pattern connection game comprising;
a. providing sets of game pieces to a group of players wherein each set of game pieces are uniquely identifiable and associated with different game players;
b. providing a substantially cylindrical polygonal shaped grid with vertical columns and horizontal columns to create a plurality of slots at the top end of the vertical columns to receive game pieces; and
c. generating a visual indicia of a random game piece grid pattern
wherein each player attempts to recreate the grid pattern by alternating turns for inserting their uniquely identified game pieces into the top of a vertical column such that the game piece falls straight down and occupies the next available space in the vertical column.

8. The method of claim 8 wherein the game pieces are selected from the group comprising markers, tokens, tiles or electronic representations of same.

9. The method of claim 8 further comprising playing cards, wherein the visual indicia of the random game piece grid pattern is displayed on the playing cards.

10. The method of claim 8 further comprising dice, wherein the visual indicia of the random game piece grid pattern is displayed on the dice.

11. The method of claim 8 wherein the polygonal grid has at least eight columns and at least eight rows.

12. The method of claim 8 wherein the game pieces are slightly smaller than the slots at the top end of the vertical columns.

13. The method of claim 1 with the device further comprising a base wherein the polygonal shaped grid fits into or onto the base and the base remains stationary while the polygonal grid rotates 360 degrees.

14. A computerized random pattern connection game for a gaming machine, comprising:
a. a central processing unit;
b. a visual display of a random pattern connection game device, the device comprising:
i. a plurality of game pieces;
ii. a substantially cylindrical polygonal shaped grid with vertical columns and horizontal columns to create a plurality of slots at the top end of the vertical columns to receive game pieces; and
iii. a visual indicia displaying at least one random game piece grid pattern.
c. at least two sets of computer-generated player game pieces;
d. a player input mechanism interfacing with said central processing unit responsive to player commands, said input mechanism including placing game pieces in the device; and
e. a computer program which
i. generates a visual indicia displaying at least one random pattern;
ii. places player game pieces on visual display of the game device in response to player commands to effect movement of said player game pieces on said visual display of device.

15. The computerized random pattern connection game for a gaming machine of claim 14 wherein the game pieces are electronic representations of tokens, tiles or markers.

16. The computerized random pattern connection game for a gaming machine of claim 14 further comprising electronic representations of playing cards, wherein the visual indicia of the random game piece grid pattern is displayed on the electronic playing cards.

17. The computerized random pattern connection game for a gaming machine of claim 14 further comprising electronic representations of dice, wherein the visual indicia of the random game piece grid pattern is displayed on the electronic dice.

18. The computerized random pattern connection game for a gaming machine of claim 14 wherein the polygonal grid has at least eight columns and at least eight rows.
